(19) United States
(12) Patent Application Publication
(10) Pub. No.: US 2021/0264253 A1
(43) Pub. Date: Aug. 26, 2021

(54) SYSTEMS AND METHODS FOR ASSISTED RESOLUTION OF SUPPORT TICKETS

(71) Applicant: UST Global (Singapore) Pte. Ltd., Singapore (SG)

(72) Inventor: Prithiviraj Damodaran, Chennai (IN)

(21) Appl. No.: 16/853,221

(22) Filed: Apr. 20, 2020

(30) Foreign Application Priority Data
Feb. 25, 2020 (IN) 202011007950

(51) Int. Cl. G06N 3/08; G06F 16/2457; G06N 3/04

(52) U.S. Cl. CPC G06N 3/08; G06N 3/0445; G06F 16/2457

(57) ABSTRACT

A system for helping resolve support tickets is configured to: (a) receive a problem query, the problem query including searchable text; (b) determine, from a ticket corpus, one or more issues similar to the problem query; (c) provide a subset of the one or more issues to a service device; (d) receive an issue selection from the service device; (e) determine one or more resolutions associated with the issue selection; (f) provide a subset of the one or more resolutions to the service device, the subset determined based on one or more features of each of the one or more resolutions, the one or more features including last activity length in user notes of the one or more resolutions; and (g) receive a resolution selection from the service device.

### PRIORITY CLAIM

This application claims priority to India Provisional Application No. 202011007950, filed Feb. 25, 2020, which is hereby incorporated by reference herein in its entirety.

### TECHNICAL FIELD

The present disclosure relates to solving support tickets and more specifically to systems and methods that provide high quality recommendations for solving support tickets.

### BACKGROUND

Issue tracking systems are computer software systems that manage and maintain lists of issues or problems that arise in an organization or that arise during the course of an individual performing certain tasks. For example, an organization may have a customer support call center for helping customers resolve various problems that arise in the course of using a service or product offered by the organization. When a customer reports a problem, then a customer support specialist can register the reported problem in an issue tracking system, associating the customer, the reported problem, and a status of the reported problem. The status of the reported problem is whether the reported problem has been resolved or whether the reported problem still needs to be addressed. The issue tracking system can thus maintain lists of issues and whether these issues have been resolved.

Issue tracking systems provide a centralized issues record such that when a problem is not resolved, a first customer support specialist can hand over the unresolved problem to a second customer support specialist with a different skillset. The second customer support specialist can then review steps already taken by the first customer support specialist to avoid repeating failed solutions. As such, issue tracking systems provide continuity between different individuals working on a same problem at different times within a workflow. Issue tracking systems persist unresolved problems until these problems are resolved or until these problems timeout.

Although issue tracking systems allow organizations to manage lists of issues, there is still room for improvement on current issue tracking systems. For example, issue tracking systems can be augmented to assist in resolving problems such that problems are solved much quicker and the need for a specialist to hand over unresolved problems to another specialist is reduced. The present disclosure provides systems and methods for further improving upon issue tracking systems.

### SUMMARY

An embodiment of the disclosure provides a system for helping resolve support tickets. The system includes a non-transitory computer-readable medium storing computer-executable instructions thereon such that when the instructions are executed, the system is configured to: (a) receive a problem query, the problem query including searchable text; (b) determine, from a ticket corpus, one or more issues similar to the problem query; (c) provide a subset of the one or more issues to a service device; (d) receive an issue selection from the service device; (e) determine one or more resolutions associated with the issue selection; (f) provide a subset of the one or more resolutions to the service device, the subset determined based on one or more features of each of the one or more resolutions, the one or more features including last activity length in user activity field of the one or more resolutions; and (g) receive a resolution selection from the service device.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a block diagram of a system for providing recommendations for support tickets according to some implementations of the present disclosure;

FIG. 2 is a flow diagram showing steps for resolving a support ticket according to some implementations of the disclosure;

FIG. 3 is a flow diagram illustrating processing steps for comparing two phrases according to some implementations of the present disclosure;

FIG. 4 is a flow diagram illustrating processing steps for providing resolution quality scores according to some implementations of the present disclosure; and

FIG. 5 is an example of a knowledge graph for relationally storing problems and resolutions.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Organizations that employ issue tracking systems sometimes enter into agreements with their customers or clients to provide a certain level of service. The metrics that quantify or the level of service to provide is usually encapsulated by a service level agreement (SLA). SLAs allow the organizations to measure their effectiveness in managing expectations of their customers or clients so that if SLAs are not met, the organizations can find a way to reimburse or compliment their customers or clients. Organizations utilize issue tracking systems to track problems, and when tracking problems, these organizations have different levels of optimization, which include, for example, reducing ticket inflow, reducing resolution turnaround time (TAT), reuse knowledge, automatically resolve tickets, etc.

In reducing ticket inflow, the organizations want to provide a great product such that not many problems are generated in the first place, or the organizations would rather have problems that can be easily binned such that not many different types of problems are generated. That way, problems can be searched through easily to determine similarities between problems. In reducing resolution TAT, the organizations strive to implement optimal ticket dispatching and assignment so that appropriate teams are selected to handle certain problems due to team expertise. By dispatching tickets to teams optimally, SLAs can be met and customer satisfaction improved. By reusing knowledge, best resolutions from history can be leveraged for new problems being faced. By automatically resolving tickets, the organizations can reduce resolution TAT and meet SLA without involvement from a human.

Embodiments of the present disclosure provide a system and method for determining high quality recommendations for solving support tickets. A reported problem included in a support ticket can have multiple resolutions from historical encounters. For example, a first problem is described as “scanner is not connecting to a photo kiosk” and a second problem is described as “photo kiosk scanner not being detected.” The first problem and the second problem are not completely identical but they are related. When the first problem was encountered, the first problem's resolution was “restarted and issue resolved.” When the second problem was encountered, the second problem's resolution was “updated the scanner drivers; reconfigured the scanner; scanner works now; refer to repository 12345 for additional details.” Compared to the second problem's resolution, the first problem's resolution is not usable since it is unclear what the underlying problem was with the communication between the scanner and the photo kiosk. As such, when presented with a similar problem as the first problem and the second problem, then embodiments of the present disclosure will provide potential solutions that are reusable, that is, solutions like the second problem's resolution. The second problem's resolution is of a higher quality than the first problem's resolution.

Embodiments of the present disclosure provide a system and method for ranking recommendations for solving support tickets such that higher quality recommendations are provided before lower quality recommendations. In the previous example with the first problem and the second problem, one resolution for each was provided. In an organization with a customer call support center that sees a similar problem described in multiple ways, help specialists may attempt different ways of resolving the problem. As such, there can be three, four, five, etc., different ways in which the problem was previously resolved. Embodiments of the present disclosure can rank these different solutions of the problem, thus providing a new help specialist with a best of many solutions, top two solutions, top three solutions, top five solutions, etc. Embodiments of the present disclosure can thus match a problem statement or phrase with historical problems in order to recommend high quality resolutions.

Embodiments of the present disclosure provide several advantages. For example, having a system and method that recommends high quality resolutions based on problem phrases can reduce and/or boost support staff training in a customer call support center. Staff expertise can be flattened in that staff will be more reliant on the system to provide a series of recommendations rather than relying heavily on personal experience. Essentially, a collective experience of the organization is being organized in a manner that can be leveraged by even a newly hired staff member with little expertise in the type of problem being encountered. Another advantage is faster resolution times, especially with experienced staff members. Customer satisfaction can be increased with a higher probability of meeting SLAs.

Embodiments of the present disclosure do not only provide advantages related to optimizing support staff and team sizes, but can help reduce overall support costs. As discussed earlier, less experienced support staff members can be hired thus reducing costs associated with hiring specialists. Furthermore, specialists can be better utilized in harder cases not yet encountered by the system. Additionally, embodiments of the present disclosure provide a system and a method for recommending resolutions to support tickets that involves minimal learning in comparison to similar systems. With minimal learning, the system can be up and running much faster compared to conventional systems. Accuracy is not greatly diminished with the minimal effort in learning, as such, embodiments of the present disclosure provide improvements to computing systems by allowing such systems to quickly understand problem statements with comparatively lower processing and storage resources.

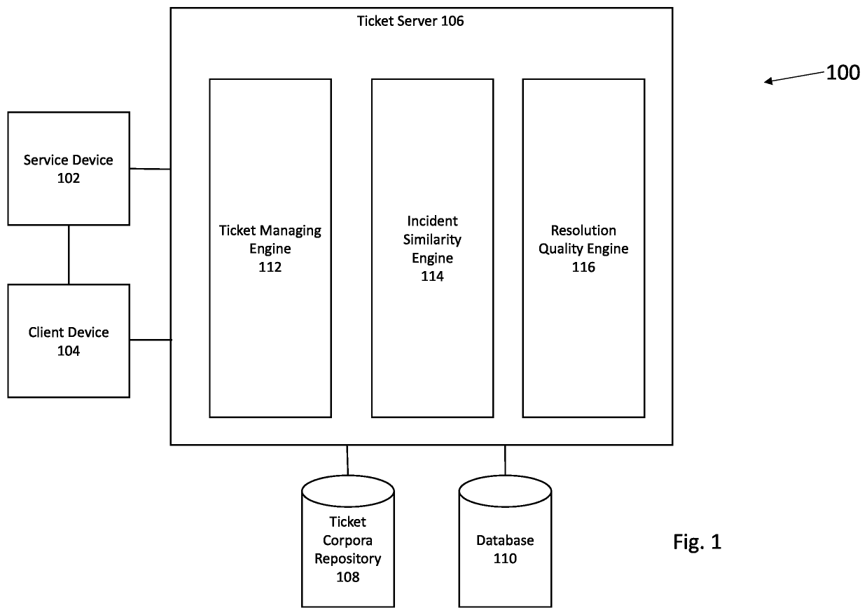

FIG. 1 illustrates a block diagram of a system 100 for providing recommendations for support tickets according to some implementations of the present disclosure. To simplify discussion, the singular form will be used for components identified in FIG. 1 when appropriate, but the use of the singular does not limit the discussion to only one of each such component. The system 100 includes a client device 104, a service device 102, a ticket server 106, a ticket corpora repository 108, and a database 110. Each of these components can be realized by one or more computer devices and/or networked computer devices. The computer devices include at least one processor with at least one non-transitory computer readable medium.

The client device 104 is any device that facilitates communication between a customer and a support staff and/or the ticket server 106. The client device 104 can be a laptop computer, a desktop computer, a smartphone, a smart speaker, a panic button, etc. The service device 102 is any device used by the support staff to assist the customer in resolving a problem. The service device 102 can be a laptop computer, a desktop computer, a smartphone, etc. The service device 102 can be in direct communication with the client device 104. In some implementations, the service device 102 communicates with the client device 104 via the ticket server 106. For example, the ticket server 106 can host a chat room or a chat box that allows the service device 102 and the client device 104 to exchange information. The service device 102 and/or the client device 104 can create tickets in the ticket server 106. Open tickets describe unresolved problems that the customer is facing. Closed tickets describe previous customer problems that have been resolved. The customer can ask the support staff to use the service device 102 to open a ticket, the customer can use the client device 104 to interact with the ticket server 106 to open a ticket, or the customer can chat with the service device 102 using the client device 104 so that the service device 102 opens a ticket.

The system 100 can maintain one or more ticket corpora in the ticket corpora repository 108. The system 100 can include the database 110 for additional information and parameter storage. Although depicted separately, the ticket corpora repository 108 and the database 110 can be combined as one repository. The ticket server 106 uses the ticket corpora repository 108 and the database 110 as storage.

The ticket server 106 includes a ticket managing engine 112, an incident similarity engine 114, and a resolution quality engine 116. An engine is a combination of hardware and software configured to perform specific functionality. The ticket managing engine 112 creates and organizes tickets in the ticket corpora repository 108. The ticket managing engine 112 can import tickets from the database 110 for use in the system 100. For example, the ticket managing engine 112 can import tickets from a ticketing software, e.g., JIRA, Service Now, ZenDesk, etc. The ticket managing engine 112 can then cleanse and prune the imported tickets. Some qualities of tickets may be discarded in the cleansing and pruning process.

In some implementations, the qualities or fields kept for each imported ticket includes a ticket identification number, a category, a subcategory, a short description, a long description, a user activity, a resolution, a ticket status, an SLA status, and dates and times associated with the user activity, the resolution, the ticket status, and the SLA status. The ticket identification number is a unique identifier of the ticket. The category can be of a select number of categories depending on the organization, e.g., general support, hardware requests, software requests, office requests, etc. The subcategory can further sort tickets within each category. The short description provides a succinct description of a ticket and can be character limited. The long description provides a detailed description and can include itemized issues and symptoms faced by a customer. The user activity includes notes on steps taken to try and resolve the problem(s) identified in the short description and/or long description. The resolution includes any steps taken that resulted in successfully resolving the problem(s). The ticket status indicates whether the ticket is still open or closed. The SLA status indicates whether the agreed-upon SLA has been met for resolving the ticket. In some implementations, the resolution field is included in the user activity field such that if a ticket is resolved, then the last activity in the user activity field can indicate the last step(s) taken to resolving the problem(s).

The incident similarity engine 114 of the ticket server 106 is configured to determine an incident similarity between a problem phrase and one or more tickets in the ticket corpora repository 108. For example, the support staff can obtain a problem description from the customer and then using the service device 102, searches for a problem phrase derived from the problem description. The incident similarity engine 114 finds tickets similar to the problem phrase.

Incident similarity does not encompass the entirety of semantic textual similarity as taught in natural language processing (NLP) literature. Sematic textual similarity is sometimes framed an unsupervised learning problem, but not all versions of semantic textual similarity can be tackled by unsupervised learning. For example, given the following phrases: phrase 1 (“Joseph Chamberlain was the first chancellor of the University of Birmingham”); phrase 2 (“Joseph Chamberlain founded the University of Birmingham”); phrase 3 (“Pele penned his first football contract with Santos FC”); and phrase 4 (“Edson Arantes do Nascimento started his football career in Vila Belmiro”). Phrase 1 and phrase 2 is easier to decipher with simple paraphrasing and language understanding. But phrase 3 and phrase 4 do not provide a hint that Pele and Edson Arantes do Nascimento are the same person and that both phrases provide a same meaning. Semantic textual similarity encompasses the scope observed in the simple paraphrasing between phrase 1 and phrase 2 and the meaning connoted between phrase 3 and phrase 4.

Incident similarity does not envelope such a large scope thus reducing the problem space considerably and improving on computation and reducing amount of training. Incident similarity according to some implementations of the present disclosure involves determining whether two problem phrases can potentially share a same resolution. Incident similarity introduces a dimension of reusability of resolutions and does not necessarily emphasize semantic similarity. For example, consider the following phrases: phrase 5 (“PPC keeps losing charge quickly”); phrase 6 (“PPC has a short battery life”); phrase 7 (“store close application not running”); and phrase 8 (“store close application not completed”). Phrases 5 and 6 are semantically similar and can share similar resolutions, but phrases 7 and 8 are not necessarily semantically similar but can share similar resolutions. The incident similarity engine 114 does not merely provide semantic similarity but also tries to determine whether two problems share a same solution.

The resolution quality engine 116 of the ticket server 106 is configured to provide a ranking of resolutions for a selected ticket that is similar to the problem phrase provided by the service device 102. The resolution quality engine 116 frames a learning to rank (LTR) problem as a supervised machine learning problem such that granularity in ranking of resolutions can be obtained. For example, in LTR, it can be difficult to provide a gradation of quality of resolutions as: very good, good, neutral, bad, and very bad. Using weak supervision, the resolution quality engine 116 can relieve the burden of labeling, thus allowing recasting of the LTR problem as a supervised machine learning problem.

The system 100 in FIG. 1 involves the ticket server 106 receiving the problem phrase from the service device 102, matching the problem phrase with one or more tickets in the ticket corpora repository 108, and then providing one or more recommendations to the service device 102 based on the matched one or more tickets.

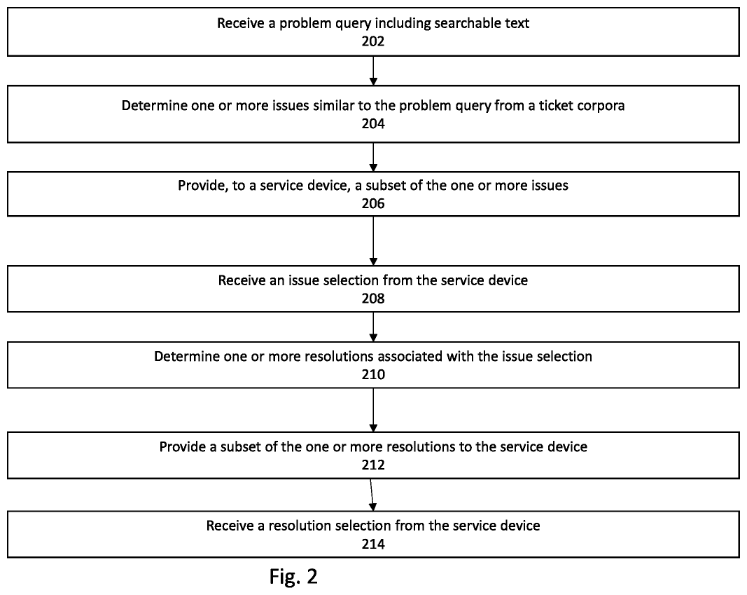

FIG. 2 is a flow diagram showing steps for resolving a support ticket according to some implementations of the present disclosure. The steps in FIG. 2 can be implemented by the ticket server 106. At step 202, the ticket server 106 receives a problem query including searchable text from the service device 102. The problem query is similar to or the same as the problem phrase already described in connection with FIG. 1. In some implementations, the problem query is received after a problem area of interest is selected by the service device 102. The ticket server 106 can prompt the service device 102 for the problem area. In some embodiments, a menu including choices of problem areas is provided. After the service device 102 provides the problem area, the ticket server 106 provides a textbox for receiving the problem query. For example, the service device 102 can receive from the service device 102 that “Photo” is the problem area, and then a textbox can be displayed on the service device 102 such that the service device 102 indicates to the ticket server 106 that the problem query is “kiosk order printing issue.”

At step 204, the ticket server 106 determines one or more issues similar to the problem query from the ticket corpora repository 108. The ticket corpora 108 contains previously created tickets. Each of the previously created tickets can include a description of an issue (or problem) that the respective ticket was tracking or is currently tracking. The ticket server 106 can use the incident similarity engine 114 to determine which tickets in the ticket corpora repository 108 are most similar to the problem query.

In some implementations, the incident similarity engine 114 computes pairwise text distance between the description of the tickets in the ticket corpora repository 108 and the problem query. Levenshtein distance and Euclidean distance are two examples of text distance metrics that can be utilized.

In some implementations, the incident similarity engine 114 utilizes neural networks in combination with text distance metrics to determine incident similarity between the description of the tickets in the ticket corpora repository 108 and the problem query. The description of the tickets in the ticket corpora repository 108 can be converted to vectors or embeddings. The incident similarity engine 114 can use a long short-term memory (LSTM) artificial recurrent neural network (RNN) for processing the embeddings. The embeddings can retain time-series information such that the LSTM network can take into account position of words to each other within description fields of tickets. The incident similarity engine 114 can use a fully connected neural network for identifying features or making decisions about whether pairwise text distance metrics indicate that two phrases are similar.

At step 206, the ticket server 106 provides, to the service device 102, a subset of the one or more issues identified at step 204. For example, at step 204, the ticket server 106 can find five issues that are similar to the problem query but only provides the top three issues. In some implementations, the ticket server 106 provides a confidence level to the similarity between the top three issues and the problem query. For example, when “kiosk order printing issue” is the problem query, the ticket server 106 can return the following issues: issue 1 (“order not processing”, 99% match); issue 2 (“receipts not printing”, 97% match); and issue 3 (“kiosk order issue”, 95% match). In some implementations, the ticket server 106 can include an option “none of the problems match my needs” to indicate that none of the provided issues matches the problem query.

At step 208, the ticket server 106 receives an issue selection from the service device 102. That is, the service device 102 selects one of the issues from the subset of the one or more issues provided at step 206. Continuing the example from step 206, the service device 102 can select issue 2 to indicate that receipts are not printing.

At step 210, the ticket server 106 determines one or more resolutions associated with the issue selected at step 208. For example, since issue 2 is selected above, resolutions associated with receipts not printing are determined by the ticket server 106. In some implementations, the ticket server 106 searches a knowledge graph to obtain resolutions of interest. In some implementations, the ticket server 106 examines the resolution fields of tickets similar to the selected issue to obtain resolutions of interest.

At step 212, the ticket server 106 provides a subset of the one or more resolutions to the service device 102. For example, the one or more resolutions can include six resolutions, but the ticket server 106 provides a top two or a top three resolutions from the six resolutions. In some implementations, the ticket server 106 uses a threshold and provides recommendations that exceed that threshold. For example, each resolution can have a resolution quality score such that only resolution quality scores that exceed a quality threshold are provided. In some implementations, resolution quality scores can take a value between 0 and 1, and only resolution quality scores that exceed 0.85 or 0.9 are provided.

Resolutions can have different features that make them reusable, and reusable resolutions are more likely to have a higher resolution quality score compared to a non-reusable resolution. Some features of interest that can affect resolution quality scores include: (a) last activity length in the user activity field, (b) verb ratio, (c) action count, (d) problem count, (e) length of user activity field, or (f) any combination thereof. The last activity length in the user activity field indicates descriptive length of the last action(s) that one or more support specialists took in trying to resolve an issue. The verb ratio describes a ratio of verbs in the latest user activity text with respect to non-verbs. The action count is a pattern of parts-of-speech tagging of text in the user activity text. The problem count is also a pattern of parts-of-speech tagging of text in the user activity text. The length of user activity field being below a certain threshold can be used to determine whether the user activity field is reasonably long to be a human typed text as opposed to copy/pasted text or machine-generated log. The last activity length in the user activity field, the verb ratio, and the length of the user activity field being below a certain threshold is serendipitous because training resolution quality scores with these features can help quickly identify better solutions.

Continuing on the previous example where issue 2 “receipts not printing” was selected, the ticket server 106 can provide three resolutions with a resolution quality score attached. For example, the ticket server 106 can provide: resolution 1 (“kiosk now loaded, printer not connected, power confirmed”, 77%); resolution 2 (“deleted old order, advised store not to reboot kiosk until printing commences”, 70%); and resolution 3 (“download files from another kiosk by executing auto update, issue resolved”, 70%). In some implementations, the ticket server 106 can include an option “none of the recommendations are satisfactory” to indicate that none of the provided resolutions will resolve the problem query.

At step 214, the ticket server 106 receives a resolution selection from the service device 102. The service device 102 picks from the provided subset of the one or more resolutions which one is the best resolution at the time. Continuing on from the example at step 212, the resolution 2 can be selected for resolving the problem query.

In FIG. 2, the selection steps, i.e., steps 208 and 214, provide a human in the loop (HITL) feedback for pruning an initial model used to determine confidence level of similarity between issues and resolution quality scores for different resolutions. That is, by providing multiple issues and/or multiple resolutions, the ticket server 106 can over time update and improve incident similarity scores between problem queries and issues and resolution quality scores for selected issues. That is, if a similar problem keeps coming up, and support staff continually match a resolution to the problem, then the matched resolution will have its resolution quality score increased while unmatched resolutions will have their resolution quality scores decreased.

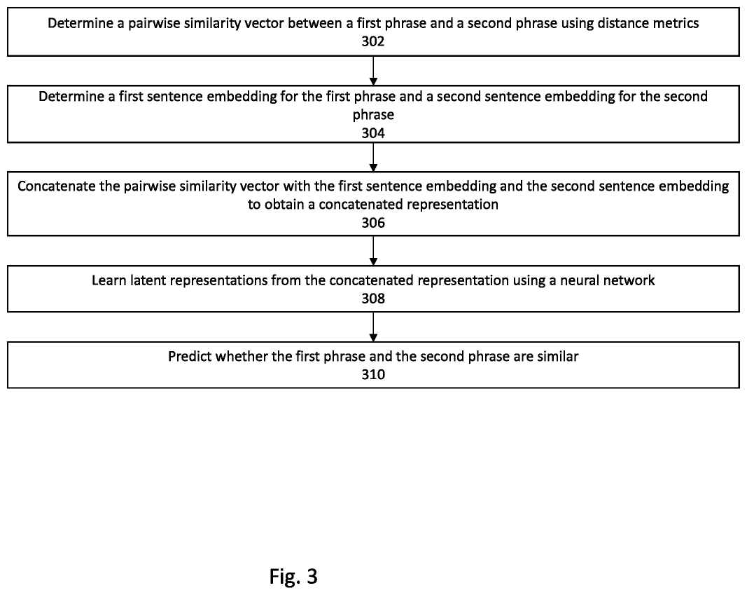

FIG. 3 is a flow diagram illustrating processing steps that the incident similarity engine 114 can use in comparing two phrases according to some implementations of the present disclosure. At step 302, the incident similarity engine 114 of the ticket server 106 determines a pairwise similarity vector between the two phrases using distance metrics. For example, the incident similarity engine 114 receives a first phrase and a second phrase. The incident similarity engine 114 calculates distance metrics between the first phrase and the second phrase. The distance metrics can include a cosine distance, a city block distance, a Jaccard distance, a Canberra distance, a Euclidean distance, a Minkowski distance, a Bray-Curtis distance, etc. For each of the different distance calculations determined for the first phrase and the second phrase, the smaller the distance calculation, the more similar the first phrase and the second phrase are to each other.

At step 304, the incident similarity engine 114 determines a first sentence embedding for the first phrase and a second sentence embedding for the second phrase. In some implementations, the first sentence embedding and the second sentence embedding are determined prior to step 302 such that distance algorithms that rely on vector space use the first sentence embedding and the second sentence embedding for determining at least one of the distance metrics of step 302.

In some implementations, the incident similarity engine 114 utilizes the GloVe (Global Vectors for Word Representation) algorithm to obtain the first and the second sentence embeddings. For example, with GloVe, each word in the first phrase or the second phrase maps on to a 300-dimension word embedding. That is, each word is replaced by a vector of 300 floating-point numbers. In an example where the first phrase contains 50 words, then the first sentence embedding will contain 300×50=15,000 floating-point numbers.

At step 306, the incident similarity engine 114 concatenates the pairwise similarity vector of step 302 with the first sentence embedding and the second sentence embedding to obtain a concatenated representation.

At step 308, the incident similarity engine 114 learns latent representations from the concatenated representation using a neural network. For example, the incident similarity engine 114 feeds the concatenated representation into Bi-LSTM layers to learn the latent representations. Latent representations describe abstractions that capture a similarity between two or more phrases in a vector space.

At step 310, the incident similarity engine 114 predicts whether the first phrase and the second phrase are similar based on the latent representations learned at step 308.

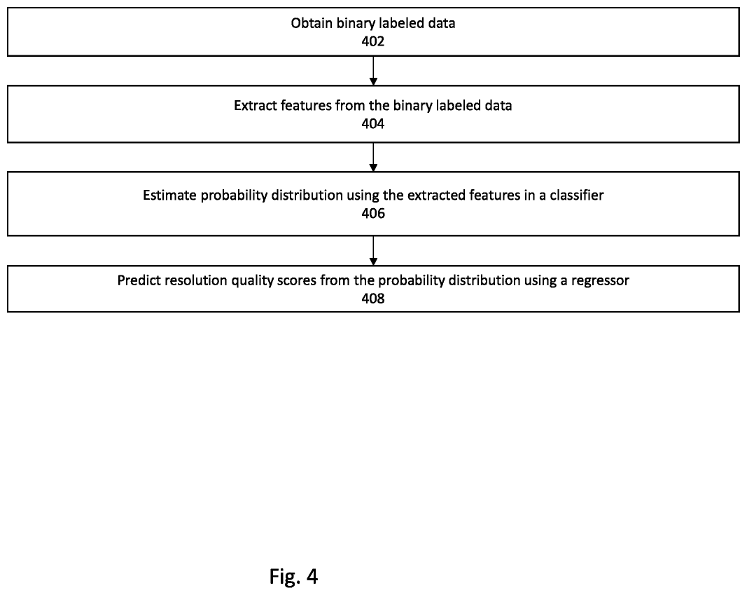

FIG. 4 is a flow diagram illustrating processing steps that the resolution quality engine 116 can use in providing resolution quality scores according to some implementations of the present disclosure. At step 402, the resolution quality engine 116 of the ticket server 106 obtains binary labeled data from the database 110 and/or the ticket corpora repository 108. The binary labeled data are ticket resolutions with tags indicating whether the resolution provided was useful or was not useful. The binary labeled data can be obtained from an initial strongly supervised model where each resolved ticket's resolution is classified as either useful or not useful. The binary labeled data can be associated with one or more problems such that such that the resolution quality engine 116 only selects a subset of the binary labeled data that is likely to be a solution for a problem or issue selected in step 208.

At step 404, the resolution quality engine 116 extracts features from the binary labeled data. Features extracted can include action count which is a pattern of parts-of-speech tagging. For example, Noun 4 Verb (e.g., system restarted, server rebooted) or Verb 4 Noun (e.g., applied the patch, upgraded the operating system). Features extracted can also include problem count which is a pattern of parts-of-speech tagging. For example, Noun 4 Adjective or Adjective 4 Noun (e.g., failed credit card payment).

Features extracted can include verb ratio, noun ratio, last activity length, activity count, adjective ratio, acronym to activity ratio, whether the length of the user activity field is below 500 characters, punctuation ratio, number ratio, adverb-pronoun ratio. The noun ratio is a ratio of nouns in the latest user activity text with respect to non-nouns. The activity count indicates a number of updates and/or steps taken to resolve a specific ticket. The adjective ratio is a ratio of adjectives in the latest user activity text with respect to non-adjectives. The acronym to activity ratio is a ratio of acronyms in the latest user activity text with respect to non-acronyms. The punctuation ratio is a ratio of punctuations in the latest user activity text with non-punctuations. The number ratio is a ratio of numbers in the latest user activity text to non-numbers (e.g., letters, punctuations, etc.). The adverb-pronoun ratio is a ratio of adverbs in the latest user activity text to pronouns in the latest user activity text.

Features extracted can include SLA status, acronym count, number value count, knowledge base count, IP address count, server name count. The SLA status indicates whether SLA has been breached or whether SLA has been met. The acronym count is a number of acronyms in the latest user activity text. The number value count indicates how many numbers are present in the latest user activity text. The knowledge base count is a number of knowledge links or universal resource locators (URLs) mentioned in the latest user activity text. The IP address count is a number of IP address mentioned in the latest user activity text. The server name count is the number of hostnames or server names mentioned in the latest user activity text. Although the aforementioned metrics or features are discussed in reference to the latest user activity text, these features can be more generalized to not merely the latest user activity text but to the user activity text in general. The latest user activity text is merely used as an example.

In some embodiments, the resolution quality engine 116 only extracts the following features: last activity length in the user activity field, verb ratio, action count, problem count, length of user activity field, or any combination thereof.

At step 406, the resolution quality engine 116 estimates a probability distribution using the extracted features in a classifier. In an example, a gradient boosted trees classifier is used by the resolution quality engine 116 to estimate the probability distribution.

At step 408, the resolution quality engine 116 predicts resolution quality scores from the probability distribution using a regressor. The combination of steps 406 and 408 is termed ensemble modeling, where the ensemble modeling highlights important features for determining good resolutions. The top resolutions with certain scores can be provided by the resolution quality engine 116 at step 212 in connection with FIG. 2. In some implementations, the ensemble modeling is an XGBoost classifier being used at step 406 and an XGBboost regressor being used at step 408.

In an example, given the following summary-resolution pairs:
1. SR pair 1 {“Scanner is not connecting to photo kiosk”, “Restarted the kiosk and issue resolved”};
2. SR pair 2 {“Photo kiosk scanner not being detected”, “Updated the scanner drivers and reconfigured it. Scanner works now. Refer to http://some.url”}; and
3. SR pair 3 {“Photo kiosk scanner not being detected”, “Resolved”}.

After performing steps 302 to 310, the incident similarity engine 114 can determine that summary of SR pair 1 and summary of SR pair 2 are similar due to having a common latent representation. While considering the resolutions of SR pair 1, SR pair 2, and SR pair 3 in connection with steps 402 to 408 in FIG. 4, the resolution quality engine 116 can determine based on extracted features that resolution quality scores for SR pair 1 is 0.81, SR pair 2 is 0.95, and SR pair 3 is 0.41. The resolution quality engine 116 can then provide resolutions for SR pair 1 and SR pair 2 to a service device in step 212 in connection with FIG. 2. A threshold can be used to make this determination, e.g., a threshold of 0.8, since resolutions for SR pair 1 and SR pair 2 have resolution quality scores that are above 0.8.

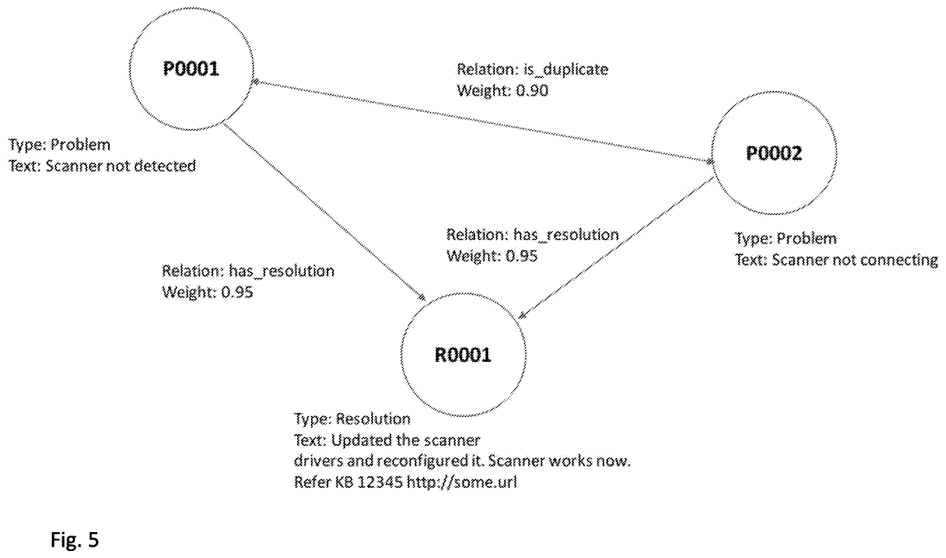

FIG. 5 is an example of a knowledge graph for storing problems and resolutions. Problems and solutions can be related by edges. For example, P0001 is related to P0002 through a similarity score indicating that both of these problems are 90% related. Both P0001 and P0002 share a common resolution. Edges for problem to resolution can indicate how well a resolution solves a problem. For example, there is a 95% confidence that R0001 is the solution to the problem P0001. Similarly, there is a 95% confidence that R0001 is the solution to the problem P0002. The edges for problem to resolution can be the resolution quality score already discussed in connection to FIG. 2.

Embodiments of the present disclosure provide several advantages. For example, ranking resolutions based on features that do not necessarily connote semantic meaning can allow a one-shot training whereby training is performed only once but used ubiquitously in a system without needing further training. That is, a model trained on a single ticket corpus can be used with unseen ticket corpora without retraining without substantially affecting quality of resolutions. Another advantage centers around using HITL to capture non-explicit feedback. By providing a gradation in issues or a gradation in resolution, feedback from support specialists can be nuanced. Nuanced feedback allows better relative weighting for incident similarity and resolution ranking.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A system for helping resolve support tickets, the system including a non-transitory computer-readable medium storing computer-executable instructions thereon such that when the instructions are executed, the system is configured to:
receive a problem query, the problem query including searchable text;
determine, from a ticket corpus, one or more issues similar to the problem query;
provide a subset of the one or more issues to a service device;
receive an issue selection from the service device;
determine one or more resolutions associated with the issue selection;
provide a subset of the one or more resolutions to the service device, the subset determined based on one or more features of each of the one or more resolutions, the one or more features including last activity length in user activity field of the one or more resolutions; and
receive a resolution selection from the service device.

2. The system of claim 1, further configured to:
receive a problem area of interest; and
determine the one or more issues in the ticket corpus based at least in part on the problem area of interest.

3. The system of claim 1, further configured to:
determine the subset of the one or more issues based at least in part on incident similarity analysis between the problem query and each of the one or more issues, wherein the subset of the one or more issues includes the one or more issues with highest incident similarity to the problem query.

4. The system of claim 3, further configured to:
perform the incident similarity analysis using one or more long short term memory (LSTM) neural networks, one or more distance metrics, one or more fully connected neural networks, or any combination thereof.

5. The system of claim 1, wherein the ticket corpus includes tickets from diverse domains.

6. The system of claim 5, wherein the subset of the one or more issues is determined based at least in part on training a machine learning model on a subset of the tickets from the diverse domains.

7. The system of claim 5, wherein the machine learning model is trained a finite number of times including one time, two times, or three times.

8. The system of claim 1, further configured to determine the subset of the one or more resolutions via resolution quality scores associated with each of the one or more resolutions.

9. The system of claim 8, wherein the resolution quality scores are determined via weak supervision.

10. The system of claim 8, wherein the resolution quality scores are further determined using the one or more features from the group consisting of: (a) verb ratio, (b) action count, (c) problem count, and (d) length of user activity field.

11. The system of claim 10, wherein the one or more features further include a noun ratio, an adjective ratio, an acronym to activity ratio, a punctuation ratio, a number ratio, or any combination thereof.

12. The system of claim 8, wherein the resolution quality scores associated with each of the one or more resolutions are determined based on ensemble modeling including a classifier and a regressor.

13. A method for helping resolve support tickets, the method performed by a computing device, the method comprising:
receiving a problem query, the problem query including searchable text;
determining from a ticket corpus, one or more issues similar to the problem query;
providing a subset of the one or more issues to a service device;
receiving an issue selection from the service device;
determining one or more resolutions associated with the issue selection;
providing a subset of the one or more resolutions to the service device, the subset determined based on one or more features of each of the one or more resolutions, the one or more features including last activity length in user activity field of the one or more resolutions; and
receiving a resolution selection from the service device.
